(19) United States
(12) Patent Application Publication
(10) Pub. No.: US 2008/0240466 A1
(43) Pub. Date: Oct. 2, 2008

(54) SIGNAL REPRODUCTION CIRCUITRY

(76) Inventors: Remco Martijn Stoutjesdijk, Edinburgh (GB); Anthony James Magrath, Edinburgh (GB)

Correspondence Address: DICKSTEIN SHAPIRO LLP, 1825 EYE STREET NW, Washington, DC, 20006-5403, US

(21) Appl. No.: 12/050,639

(22) Filed: Mar. 18, 2008

(30) Foreign Application Priority Data
Mar. 30, 2007 (GB) 0706333.2

(51) Int. Cl. H04B 15/00

(52) U.S. Cl. 381/94.8

(57) ABSTRACT

A sound reproduction device includes a filter, which detects a repeated bit sequence of a predetermined length in an input bit stream. When any repeated bit sequence having the predetermined length is detected, the input bit stream is applied to a filter for attenuating signals at the frequency corresponding to the predetermined length.

### BACKGROUND OF THE INVENTION

1. Field of the Invention

This invention relates to signal reproduction circuitry, in particular for use in an audio reproduction device, and to a method of operation of such signal reproduction circuitry.

2. Description of the Related Art

It is known in audio reproduction devices to use sigma-delta modulation to encode data for storage or transmission over a transmission channel. For example, in the Direct Stream Digital (DSD) data format used for encoding data for storage on Super Audio Compact Discs (SACDs), a 1-bit sigma-delta modulator is used.

In order to allow such a system to reproduce an audio signal accurately, a high sampling rate is used, and the quantization error is fed back into the system through a lowpass filter, so that the quantization noise is moved into the inaudible ultrasonic frequency range. The result is that a large proportion of the signal power of the encoded signal is located at ultrasonic frequencies.

In a playback device, a filter is then used to remove the ultrasonic noise, in order to protect the amplifier and speakers. This is effective, provided that the noise distribution is essentially constant over the ultrasonic frequency range.

However, situations can occur in which the ultrasonic power is concentrated at a single frequency or set of frequencies. Although these frequencies are in the inaudible ultrasonic range, they can overload the amplifier or speakers in the playback system. In such circumstances, the filter may be able to remove only a small part of the ultrasonic power, and the remaining ultrasonic power may cause audible artefacts or even damage to the amplifier or speakers in the playback system.

### SUMMARY OF THE INVENTION

According to a first aspect of the present invention, there is provided a filter device, comprising:
a pattern detector, for detecting a repeated bit pattern of a predetermined length in an input data stream; and
a cyclic pattern filter, for generating a filtered output signal from said input data stream when said pattern detector detects a repeated bit pattern of the predetermined length in the input data stream, said cyclic pattern filter being suitable for attenuating a component of said output signal at a frequency corresponding to said predetermined length repeated bit pattern.

According to a second aspect of the present invention, there is provided a method of filtering a signal, comprising:
detecting a repeated bit pattern of a predetermined length in an input data stream; and
   generating a filtered output signal from said input data stream when said pattern detector detects a repeated bit pattern of the predetermined length in the input data stream, by attenuating a component of said output signal at a frequency corresponding to the predetermined length repeated bit pattern.

This has the advantage that, when a repeated bit pattern is detected, frequency components at the frequency corresponding to the repeated bit pattern are removed or attenuated.

### BRIEF DESCRIPTION OF THE DRAWINGS

For a better understanding of the present invention, and to show how it may be put into effect, reference will now be made, by way of example only, to the accompanying drawings, in which:

FIG. 1 is a block schematic diagram of an audio reproduction system, in accordance with an aspect of the present invention.

FIG. 2 is a block schematic diagram of a filter in the audio reproduction system of FIG. 1.

FIG. 3 is a block schematic diagram of a first component of the pattern detector in the filter of FIG. 2.

FIG. 4 is a block schematic diagram of a second component of the pattern detector in the filter of FIG. 2.

FIG. 5 is a block schematic diagram of a pattern filter in the filter of FIG. 2.

FIG. 6 is a block schematic diagram of an alternative form of pattern filter in the filter of FIG. 2.

FIG. 7 is a flow chart, illustrating a method of operation of the audio reproduction system, in accordance with an aspect of the present invention.

FIG. 8 illustrates the operation of the filter of FIG. 2.

### DETAILED DESCRIPTION OF THE PREFERRED EMBODIMENTS

FIG. 1 is a block schematic diagram, illustrating an audio signal reproduction system 10. The system includes a signal reproduction device 12, for example for reading a stored signal from a storage medium. In one embodiment of the invention, the stored signal has been encoded on an optical disc using the Direct Stream Digital (DSD) data format and the signal reproduction device is a Super Audio Compact Disc (SACD) player. The signal reproduction device 12 thus generates a 1-bit data stream.

The 1-bit data stream is applied to digital filter circuitry 14, which will be described in more detail below, but whose function, in general terms, is to remove as far as possible the unwanted ultrasonic components of the encoded signal.

The filtered multi-bit sigma-delta signal output from the filter 14 is applied to a multi-bit sigma-delta digital-analogue (D/A) converter 16, which reconstructs the original analogue signal waveform.

The D/A converter output signal is then applied to an analogue lowpass filter 18 to further smooth the signal. The resulting signal is applied to an amplifier 20, which then drives the loudspeaker 22.

Although an illustrative audio signal reproduction system 10 is shown in FIG. 1, it will be appreciated that many variations are possible, and that the components of the system may be contained in a single unit or in multiple units, as appropriate.

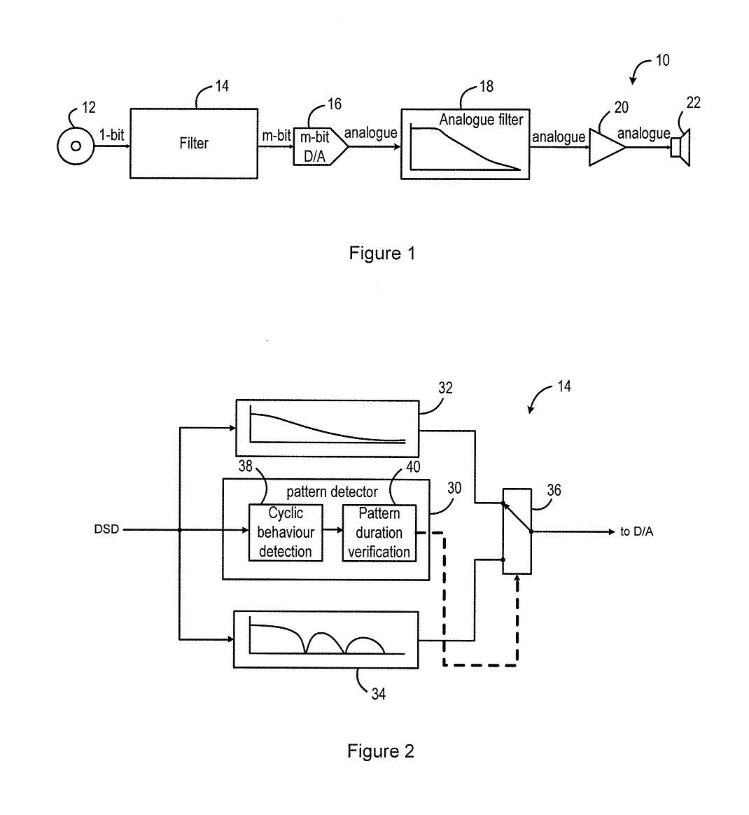

FIG. 2 shows in more detail the form of the digital filter circuitry 14 in the system 10. Specifically, the 1-bit DSD format data stream is applied to a pattern detector 30, and to two separate filter blocks, namely an ultrasonic noise filter 32 and a cyclic pattern filter 34. Outputs from the ultrasonic noise filter 32 and the cyclic pattern filter 34 are applied as inputs to a switch 36, which selects one of these inputs based on a control signal from the pattern detector 30, and produces a filtered output signal that is passed to the D/A converter 16 as described above.

The pattern detector 30 includes a cyclic behaviour detection block 38, for detecting cyclic behaviour in the DSD format input data stream, and a pattern duration verification block 40, for determining that the cyclic behaviour is sufficiently persistent that action should be taken to prevent it from impacting on the output signal.

For example, a sigma-delta modulator can become unstable, in which case the data stream may contain a repeating pattern of bits, which will have the effect of concentrating noise power at one frequency or set of frequencies. Also, the Super Audio CD (SACD) standard defines a silence pattern. Again, if this pattern persists, it will have the effect of concentrating noise power at one frequency or set of frequencies.

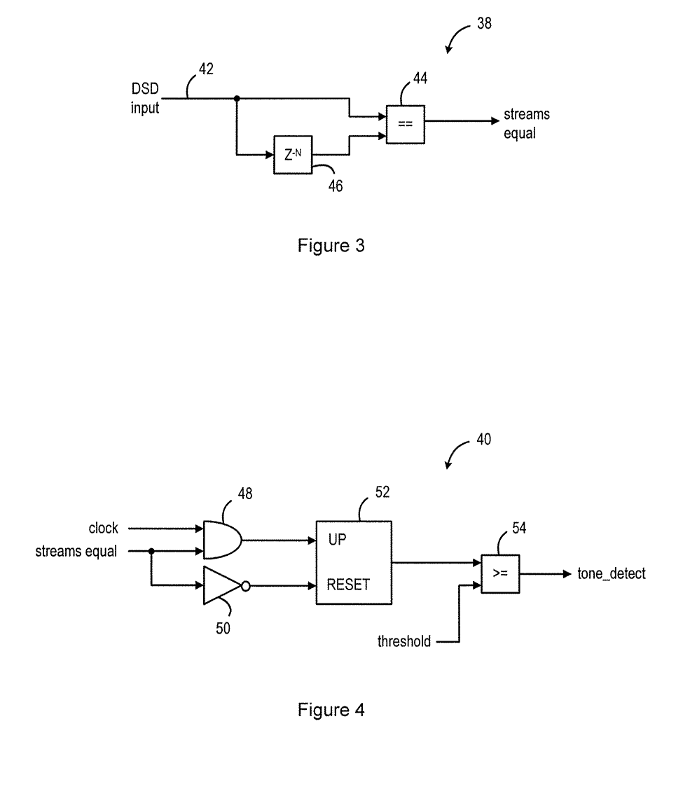

FIG. 3 illustrates one possible form of the cyclic behaviour detection block 38. Specifically, the DSD data format data stream is supplied to one input of a comparator 44. At the same time, the input data stream is applied to a delay element 46 that delays the bit stream by N sample periods. The value of N is selected to be equal to the length of the repeated bit pattern that is expected to be found in the input data stream. For example, the Super Audio CD (SACD) standard, mentioned above, defines a silence pattern comprising a repeated 8-bit pattern. In order to be able to able to detect such an 8-bit pattern, the value of N is set equal to 8.

The delayed bit stream from the delay element 46 is applied to a second input of the comparator 44, which produces an output signal when the current value of the input data bit is equal to the bit value of the delayed bit stream.

FIG. 4 illustrates one possible form of the pattern duration verification block 40, which determines whether there is in fact a pattern in the input data stream, persisting for a considerable amount of time. Thus, the pattern duration verification block 40 counts the number of consecutive cycles during which the cyclic behaviour detection block 38 produces an output signal, and determines when this number of cycles is sufficient to determine that there is a pattern persisting in the input data stream.

The output signal from the cyclic behaviour detection block 38 is applied to a first input of an AND gate 48, the second input of which receives the clock signal used to synchronize the circuitry to the received bit stream. Thus, the AND gate 48 produces output clock pulses during the period when the cyclic behaviour detection block 38 is producing an output signal. The output signal from the cyclic behaviour detection block 38 is also applied to an inverter 50, which thus produces a high level output signal during the period when the cyclic behaviour detection block 38 is not producing an output signal.

Clock pulses from the AND gate 48 are applied to an UP input of a counter 52, which counts the number of such clock pulses that it receives. At the same time, the output signal from the inverter 50 is applied to a RESET input of the counter 52. Thus, the counter value is reset to zero whenever the cyclic behaviour detection block 38 stops producing an output signal.

The counter value from the counter 52 is applied to a first input of a comparator 54, which receives a threshold value as its second input. The comparator produces a high level output signal when the counter value from the counter 52 becomes equal to or greater than the threshold value. The threshold value is chosen based on the form of the actual data stream, including the effects of any noise shaping algorithms, in order that any pattern can be detected as quickly as possible, while minimizing the possibility of a false positive pattern detection.

Thus, when the comparator 54 produces a high level output tone_detect signal, it is known that the input data stream contains a bit pattern, having a length of N bits, that has persisted for enough repetitions to be able to assume that there is a pattern in the input data, rather than merely a coincidental repetition.

The tone_detect signal from the comparator 54 is supplied as a control input to the switch 36 illustrated in FIG. 2. When this control input is low, i.e. when the comparator does not detect a repeating pattern, the switch 36 outputs the input signal received from the ultrasonic noise filter 32. The ultrasonic noise filter 32 may be a conventional filter for suppressing signals at ultrasonic frequencies without substantially attenuating signals at audio frequencies (for example suppressing signals above 20 kHz), and having a frequency response such that the amplitudes of signals are reduced by greater amounts at increasing frequencies as is known in the art. Thus the ultrasonic noise filter 32 will not be described further.

When this control input is low, i.e. when the comparator 54 has detected a repeating pattern, the switch 36 outputs the input signal received from the cyclic pattern filter 34. The cyclic pattern filter output is therefore brought into action when a bit pattern, having a length of N bits and hence a corresponding frequency of fₛ/N, where fₛ is the sampling frequency of the data, has be detected. If no corrective action is taken, such a repeating pattern would generate a large signal at this frequency, which the ultrasonic noise filter 32 may be unable to remove to a sufficient extent to protect the amplifier 20 and speaker 22.

The cyclic pattern filter 34 is therefore designed, for example as a notch filter or a comb filter, such that it can remove signals at the frequency of fₛ/N.

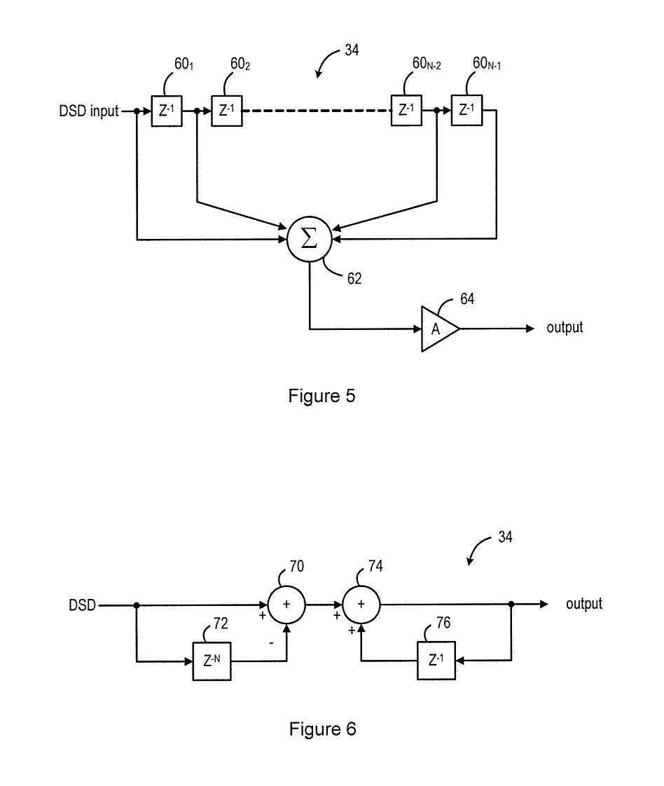

FIG. 5 is a schematic diagram, illustrating one possible form of the filter 34. Specifically, the DSD format input data stream from the playback device 12 is applied to a series of (N-1) delay units 60₁, 60₂, . . . , 60_{N-2}, 60_{N-1}, each of which delays the signal by one sample period. The current input sample, and the outputs from the delay units 60₁, 60₂, . . . , 60_{N-2}, 60_{N-1}, are then applied to an adder 62. The value output from the adder 62 is then scaled in a multiplier or amplifier 64 by a value A to ensure that the gain of the cyclic pattern filter 34 matches that of the ultrasonic noise filter 32.

It can thus be seen that the value output from the adder 62 at any time is the sum of the value of the current input sample and the values of the (N-1) immediately preceding samples.

That is, the output value y at a current time iT, where T is the sampling period, is based on input values x as follows:

$$y ( iT ) = {\sum }_{n = 0}^{n = N - 1} x ( iT - nT )$$

FIG. 6 illustrates an alternative form of the cyclic pattern filter 34, having the same properties, but having reduced hardware complexity, particularly for relatively large values of N.

Specifically, the DSD format input data stream from the playback device 12 is applied to one input of a first adder 70, and is also applied to a first delay unit 72 that delays the signal by N sample periods. The output of the first delay unit 72 is applied to a second input of the first adder 70, and subtracted from the first input.

The output of the first adder 70 is applied to a first input of a second adder 74, the output of which is fed back to a second delay unit 76, which delays the signal by one sample period. The output from this second delay unit 76 is applied to a second input of the second adder 74. The output of the second adder 74 is then also used as the output of the filter circuit 34.

The cyclic pattern filter 34, either as shown in FIG. 5 or FIG. 6, therefore produces a filter output that is equal to (or proportional to) the sum of the most recent N input values, including the current input value. Since this summing period matches the repetition period of the pattern in the input data, the filter output will be constant, and the output value will be equal to the sum of the data over that repetition period.

For example, when the input data stream is +1 +1 +1 −1 +1 +1 +1 −1+1 +1 +1 −1 etc, the repetition length N is equal to four samples, and the sum of any four consecutive bits in the input stream is equal to +2, irrespective of the position of those four bits in the input data stream, for as long as the cyclic behaviour persists.

In the frequency domain, the frequency response H(f) of the cyclic pattern filter 34, either as shown in FIG. 5 or FIG. 6, at a frequency f can be described as:

$$H ( f ) = 2 \vert \frac{sin ( \frac{π f N}{{f}_{s}} )}{\frac{π f}{{f}_{s}}} \vert$$

This illustrates that there is no attenuation at DC, and that there is minimal attenuation at audio frequencies such that the audio band information is intact, but that the filter response is zero (i.e. maximum attenuation) at a frequency f=fₛ/N and multiples thereof.

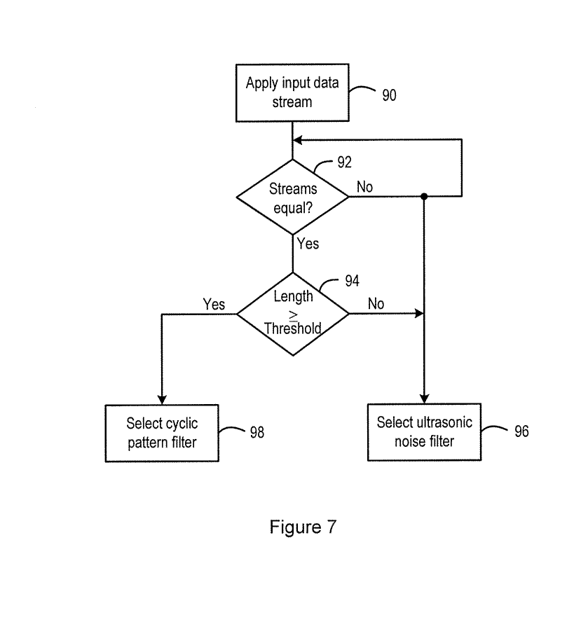

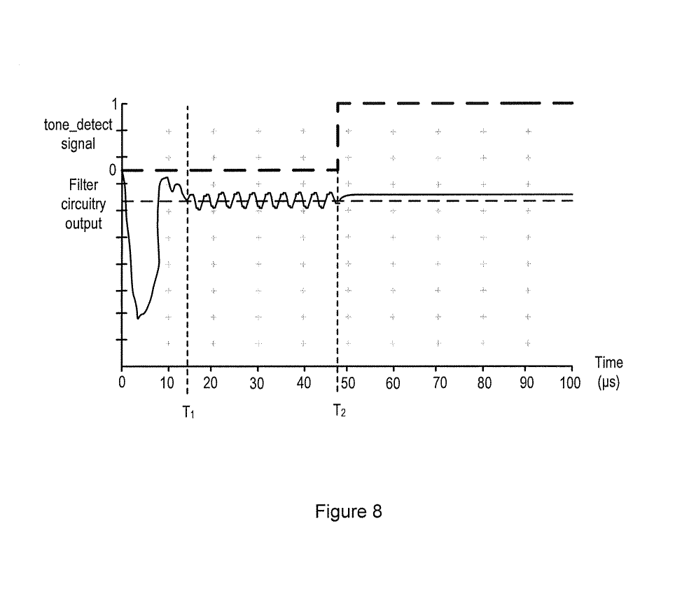

FIG. 7 is a flow chart, illustrating the method of operation of the filter circuitry 14, in accordance with an aspect of the invention, and FIG. 8 illustrates signals generated by the filter circuitry 14 during this operation.

Thus, in step 90, the input data stream is applied to the filter circuitry 14 and, in step 92, the cyclic behaviour detection block 38 tests whether the current value of the input data bit is equal to the bit value of the delayed bit stream, as described above with reference to FIG. 3. If current value of the input data bit does not equal the bit value of the delayed bit stream, the process returns to step 92 for the test to be performed on the next received sample value.

If it is found in step 92 that the current value of the input data bit does equal the bit value of the delayed bit stream, a signal is passed to the pattern duration verification block 40, which determines in step 94 whether the length of the repeating sequence exceeds a threshold, as described above with reference to FIG. 4.

If it is determined that the length of the repeating sequence does not exceed the threshold, the process passes to step 96, in which the ultrasonic noise filter 32 is selected for use. The ultrasonic noise filter 32 is also selected for use if there is no detection in step 92 of a repeating pattern.

If it is determined in step 94 that the length of the repeating sequence does exceed the threshold, the process passes to step 98, in which the cyclic pattern filter 34 is selected for use.

FIG. 8 illustrates the operation of the filter circuitry 14, in one illustrative example situation. As shown in FIG. 8, during the time period up to T₁, there is no repeating pattern in the input data, and so the tone_detect signal has a low level, and the standard filter circuitry 32 is engaged.

At the time T₁, the data becomes cyclic. For example, it may contain the repeated eight bit pattern −1 +1 −1 −1 −1 +1 +1 −1. That is, the repetition length N=8. At this time, the output starts to show a cyclical pattern, and the pattern duration verification block 40 starts to count the number of samples for which the pattern persists.

At the time T₂, the counted number of samples reaches the threshold value and the comparator 54 outputs a high level tone_detect signal, as shown by the dashed line in FIG. 8. At this time, the switch 30 selects the output of the cyclic pattern filter 34, and thereafter the filter output becomes equal to the average of the signal level during the cyclic period between T₁ and T₂. Thus, the tonal behaviour of the output signal is eliminated.

The fact that the filter output becomes equal to its previous average level means that there are no glitches or sudden level changes that might adversely affect the output signal quality which is advantageous.

When the pattern in the input data ends, the standard filter circuitry 32 is re-engaged and, at this time, the substantially constant level output transitions into an output signal, again without glitches, which is again advantageous.

There is thus described a system for removing the effects of patterns in the input signal data stream.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

It is noted that the invention may be used in a number of applications. These include, but are not limited to, consumer applications and automotive applications. For example, typical consumer applications include laptops, mobile phones, PDAs and personal computers. Typical automotive applications include in-car, in-train and in-plane entertainment systems.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfill the functions of several units recited in the claims. Any reference signs in the claims shall not be construed so as to limit their scope.

What is claimed is:

1. A filter device, comprising:
a pattern detector, for detecting a repeated bit pattern of a predetermined length in an input data stream; and
a cyclic pattern filter, for generating a filtered output signal from said input data stream when said pattern detector detects a repeated bit pattern of the predetermined length in the input data stream, said cyclic pattern filter being suitable for attenuating a component of said output signal at a frequency corresponding to said predetermined length repeated bit pattern.

2. A filter device as claimed in claim 1, further comprising:
a noise filter, for generating a filtered signal from said input data stream; and
a switch for selecting the filtered output signal generated by the cyclic pattern filter as an output signal of the filter device when said pattern detector detects a repeated bit pattern of the predetermined length in the input data stream, and for selecting the filtered signal generated by the noise filter when said pattern detector does not detect a repeated bit pattern of the predetermined length in the input data stream.

3. A filter as claimed in claim 1, wherein the pattern detector comprises:
a cyclic behaviour detector, for determining when a current bit value of the input data stream equals the bit value of the input data stream at a previous time separated by said predetermined length; and
a pattern duration verification block, for determining when current bit values of the input data stream have equalled the bit values of the input data stream at previous times separated by said predetermined length for a threshold number of said bit values.

4. A filter as claimed in claim 1, wherein the cyclic pattern filter comprises a comb filter, having a minimum in its frequency response at said frequency corresponding to said predetermined length repeated bit pattern.

5. An audio reproduction system, comprising:
a playback device, for generating a data stream from a data storage medium; and
a filter device as claimed in any preceding claim, for receiving said data stream as its input data stream.

6. An audio reproduction system as claimed in claim 5, for generating a data stream in accordance with a predefined data format, wherein said data format includes a silence pattern comprising a repeated bit sequence having a predefined length, and wherein said pattern detector is for detecting a repeated bit pattern of said predefined length in said input data stream.

7. An audio reproduction system as claimed in claim 5, wherein said filter device is as claimed in claim 2, and wherein said noise filter is adapted to attenuate tones at ultrasonic frequencies without substantially attenuating tones at audio frequencies.

8. An electronic device comprising an audio reproduction system as claimed in claim 5.

9. A communications device comprising an audio reproduction system as claimed in claim 5.

10. A computer device comprising an audio reproduction system as claimed in claim 5.

11. A vehicle entertainment system, comprising an audio reproduction system as claimed in claim 5.

12. A method of filtering an input data stream, comprising:
detecting a repeated bit pattern of a predetermined length in an input data stream; and
generating a first filtered output signal from said input data stream in response to a detection of a repeated bit pattern of the predetermined length in the input data stream, by attenuating a component of said output signal at a frequency corresponding to said predetermined length repeated bit pattern.

13. A method as claimed in claim 12, further comprising:
generating a second filtered signal from said input data stream; and
selecting the first filtered output signal as an output signal of the filter device in response to a detection of a repeated bit pattern of the predetermined length in the input data stream, and selecting the second filtered signal as an output signal of the filter device when repeated bit pattern of the predetermined length is detected in the input data stream.

14. A method as claimed in claim 12, comprising:
determining when a current bit value of the input data stream equals the bit value of the input data stream at a previous time separated by said predetermined length; and
determining when current bit values of the input data stream have equalled the bit values of the input data stream at previous times separated by said predetermined length for a threshold number of said bit values.

15. A method as claimed in claim 12, comprising generating the first filtered output by means of a comb filter, having a minimum in its frequency response at said frequency corresponding to said predetermined length repeated bit pattern.

16. A method as claimed in claim 12, comprising receiving said input data stream from an audio playback device.

17. A method as claimed in claim 16, wherein said data stream is in accordance with a predefined data format, including a silence pattern comprising a repeated bit sequence having said predetermined length.
